(19) United States
(12) Patent Application Publication
(10) Pub. No.: US 2024/0227988 A9
(43) Pub. Date: Jul. 11, 2024

(54) WATER BOARD FIN PROVIDED WITH A HINGE WHICH IS SELF-LOCKING IN A STABILIZING POSITION AND A FOLDED POSITION

(71) Applicant: EQUIP CLUB SA, Rolle (CH)

(72) Inventor: Daniel SCHMÄH, Etay (CH)

(73) Assignee: EQUIP CLUB SA, Rolle (CH)

(21) Appl. No.: 18/264,084

(22) PCT Filed: May 23, 2022
(86) PCT No.: PCT/EP2022/063928

§ 371 Date: Aug. 3, 2023

(30) Foreign Application Priority Data
Jun. 11, 2021 (FR) 2106205

(51) Int. Cl. B63B 32/64

(52) U.S. Cl. CPC B63B 32/64

(57) ABSTRACT

A fin intended for a navigation object, in particular an inflatable or rigid-shell water board, including a wing which is able to move with respect to a fastening base about an axis of rotation between a first “stabilizing” position and a second “folded” position, and a rotation blocking element for blocking the wing in the folded position, the axis of rotation being borne by two hinge components, one of which is fastened to the wing and the other to the fastening base, the hinge component fastened to the wing also being able to move translationally with respect to the hinge component fastened to the fastening base in order to unblock the wing.

### FIELD

The invention relates to a fin intended for a navigation object, in particular an inflatable or rigid-shell water board, for example a surfboard, a standup paddle or a windsurf board. The navigation object comprises a wing which is able to move with respect to a fastening base about an axis of rotation between a first “stabilizing” position and a second “folded” position, and rotation blocking means for blocking the wing in the folded position, the axis of rotation being borne by two hinge components, one of which is fastened to the wing and the other to the fastening base, the hinge component fastened to the wing also being able to move translationally with respect to the hinge component fastened to the fastening base in order to unblock the wing.

### BACKGROUND

A fin of this type is disclosed by document U.S. Pat. No. 9,487,276. The blocking means comprise a notch borne by the hinge component fastened to the fastening base cooperating with an opening formed in the wing in order to unblock the wing from the folded position, under the action of a torsion spring mounted along the axis of rotation. The opening is aligned with the notch by translating the hinge component fastened to the wing. Note that the torsion spring is not stressed during the translation, since it is enclosed in a housing of the hinge component fastened to the fastening base. Once unblocked from the folded position, the wing is free to rotate against the deformation of the torsion spring to adapt the stabilizing force to the water current lines.

Document WO 2005/105566 discloses a fin of another type, wherein the two hinge components block all translational movement of the wing with respect to the fastening base. The fastening base of one of the hinge components is inserted in a box of the navigation object. The other hinge component fastened to the wing is able to move between three angular positions defined by a ruler, inserted between the two components along the axis of rotation. The ruler is used to block the wing in one of the three angular positions.

Other examples of this type of fin are provided by documents U.S. Pat. Nos. 5,664,979 and 5,813,890, wherein the wing can move between two angular positions, defined by a stop borne by the hinge component fastened to the fastening base. Between these two positions, the wing is once again free to rotate against the torsional deformation of a spring to adapt the stabilizing force to the water current lines. Document WO 2012/009753 discloses a similar fin.

Document DE 102 13 44 discloses a fin having a fastening base that is fastened to the actual shell of the navigation object. The elastic means is compressed to block the wing in the stabilizing position and not to unblock it. The blocking means are borne by the hinge component fastened to the boat shell and by one end of the hinge component fastened to the wing. The elastic means is arranged at this end and is compressed by a traction cable, connected to the opposite end by a plug. When the cable is slackened by a user, the elastic means also slackens to uncouple the two hinge components and allow the wing to rotate. The fin can be removed from the boat shell, provided that the plug of the hinge component fastened to the wing is removed to release the traction cable.

Document U.S. Pat. No. 1,703,868 discloses another fin having a fastening base that consists of the actual shell of the navigation object, in this case a motor boat. The wing is moved between the stabilizing position and the folded position by a lever attached to the axis of rotation and the rotation blocking means for blocking the wing in the stabilizing position are fastened to the shell. The folded position corresponds to a docking or shallow water position and is stable.

Lastly, document EP 0 034 990 discloses a fin having a wing that can move between a stabilizing position and a folded position, only in rotation about an axis of rotation extending perpendicular to a longitudinal direction of the fastening base.

### SUMMARY

One purpose of the invention is thus to modify a fin of the type which has been described in the introduction, to allow the wing to rotate between two stable angular positions, the fin being compatible with a removable fastening base.

To this end, the invention relates to a fin intended for a navigation object, in particular an inflatable or rigid-shell water board, comprising a wing which is able to move with respect to a fastening base about an axis of rotation between a first “stabilizing” position and a second “folded” position, and rotation blocking means for blocking the wing in the folded position, the axis of rotation being borne by two hinge components, one of which is fastened to the wing and the other to the fastening base, the hinge component fastened to the wing also being able to move translationally with respect to the hinge component fastened to the fastening base in order to unblock the wing, characterized in that the rotation blocking means are borne by the two hinge components in order to block the wing in the folded position and in the stabilizing position and in that it comprises an elastic means that deforms in compression or in bending, against the translational movement of the hinge component fastened to the wing, unblocking the wing from the stabilizing position.

The axis of rotation extends parallel to a longitudinal direction of the fastening base.

The elastic means keeps the wing blocked in rotation in the stabilizing position while allowing it to move in translation, against the deformation in bending or in compression of the elastic means to unblock it.

According to a first embodiment of the invention, the elastic means is a compression spring mounted about the axis of rotation, between a first part of the hinge component fastened to the fastening base and the hinge component fastened to the wing and opposite the rotation blocking means, borne by the hinge component fastened to the wing and by a second part of the hinge component fastened to the fastening base, said spring deforming in compression against the translational movement of the hinge component fastened to the wing in order to unblock the wing from the stabilizing position or from the folded position.

In this embodiment, the wing is moved in translation along the axis of rotation against the compression of the spring, up to a position that is free to rotate, for which the blocking means are unblocked from each other. These means define two positions that are stable in rotation, the stabilizing position and the folded position, that are preferably 90° apart from each other.

According to a second embodiment of the invention, the elastic means is a bending arm borne by the hinge component fastened to the wing, both of these two elements being pierced by an oblong hole into which the axis of rotation is inserted, the means for blocking the hinge component fastened to the wing being borne by the bending arm, which deforms in bending, against the translational movement of the hinge component fastened to the wing in order to unblock the wing from the stabilizing position and against a rotational movement about the axis of rotation, in order to unblock the wing from the folded position.

In this embodiment, the wing is moved in translation along the oblong hole up to a position that is free to rotate, for which the blocking means are unblocked from each other. These means define once again two positions that are stable in rotation, the stabilizing position and the folded position, that are preferably 90° apart from each other.

In either embodiment, the wing can be moved between the two positions that are blocked in rotation, of which one corresponds to the stabilizing position when the height of water under the navigation object is sufficient, and the other, to the folded position, preferably at 90°, when the height of water is not sufficient.

The elastic means thus gives the fin a self-blocking property, by which the two hinge components block the wing with respect to the fastening base, independently of the navigation object on which the fin is mounted. In other words, the fin according to the invention can be moved between two stable angular positions, one stabilizing and the other folded, while being removably assembled to the navigation object, in particular an inflatable or rigid-shell water board.

### BRIEF DESCRIPTION OF THE FIGURES

FIG. 1 shows a first embodiment of a fin according to the invention.

FIG. 2 is a detail view of reciprocal rotation blocking means borne by a hinge component fastened to a fastening base of the fin.

FIG. 3 is a detail view of rotation blocking means borne by a hinge component fastened to the wing of the fin.

FIG. 4 is a detail view of two hinge components of the fin, in a position that is blocked in rotation for which the wing of the fin is in the stabilizing position.

FIG. 5 is a detail view of two hinge components of the fin, in a position that is blocked in rotation for which the wing of the fin is in the folded position.

FIG. 6 is a detail view of two hinge components of the fin, in a position that is unblocked in rotation.

FIG. 7 shows an assembly between the fin and an inflatable water board, the wing being in the stabilizing position.

FIG. 8 shows an assembly between the fin and a rigid-shell water board, the wing being in the stabilizing position.

FIG. 9 shows an assembly between the fin and an inflatable water board, the wing being in the folded position.

FIG. 10 shows an assembly between the fin and a rigid-shell water board, the wing being in the folded position.

FIG. 11 shows a second embodiment of a fin according to the invention.

FIG. 12 is a detail view of two hinge components of the fin, in a position that is blocked in rotation in which a wing of the fin is in a stabilizing position.

FIG. 13 is a detail view of two hinge components of the fin, in a position that is blocked in rotation in which a wing of the fin is in a folded position.

FIG. 14 is a detail view of two hinge components of the fin, in a position that is unblocked in rotation.

FIG. 15 shows another assembly between the fin and an inflatable water board according to the first embodiment, the wing being in the stabilizing position.

FIG. 16 shows another assembly between the fin and an inflatable water board according to the second embodiment, the wing being in the stabilizing position.

Note that in the following description, the same element is designated by the same reference on all the FIGURES.

### DETAILED DESCRIPTION

A fin intended for a navigation object, in particular an inflatable or rigid-shell water board, comprises, according to the various embodiments, a wing 1 which is able to move with respect to a fastening base 3 about an axis of rotation A1 between a first “stabilizing” position and a second “folded” position. The fin also comprises rotation blocking means 15, 17; 35, 37 to block the wing 1 in the stabilizing position. The axis of rotation A1 is borne by two hinge components 5 and 7. One 5 is fastened to the wing 1 and the other 7 to the fastening base 3. The hinge component 5 fastened to the wing 1 is also able to move translationally with respect to the hinge component 7 fastened to the fastening base 3 in order to unblock the wing 1 from the stabilizing position. The axis of rotation A1 extends parallel to a longitudinal direction L of the fastening base.

According to the invention, the rotation blocking means 15, 17; 35, 37 are borne by the two hinge components 5, 7 in order to block the wing in the stabilizing position and in the folded position. The fin also comprises an elastic means 11, 31 which deforms in compression or in bending to exert a return force on the hinge component 5 fastened to the wing 1, against the translational movement with respect to the hinge component 7 fastened to the fastening base 3, unblocking the wing 1 from the stabilizing position.

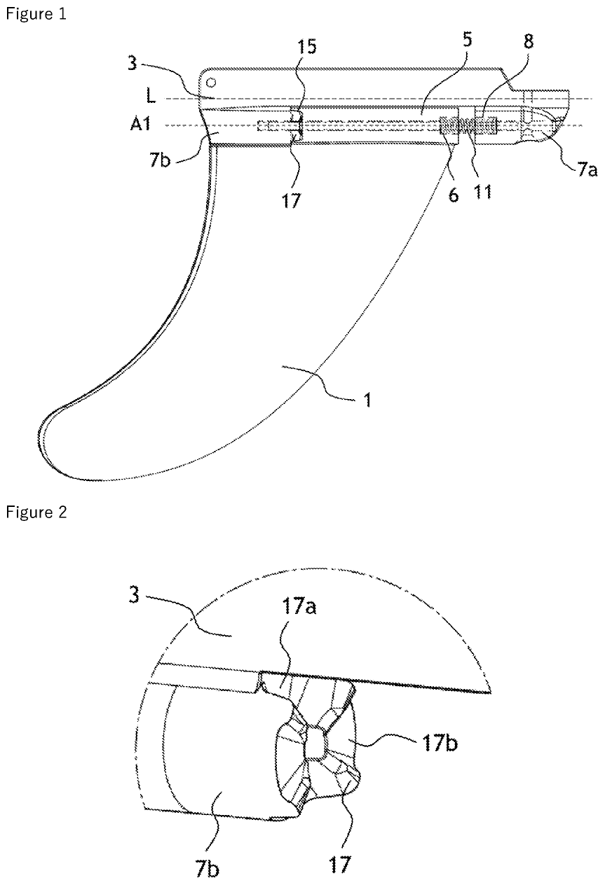

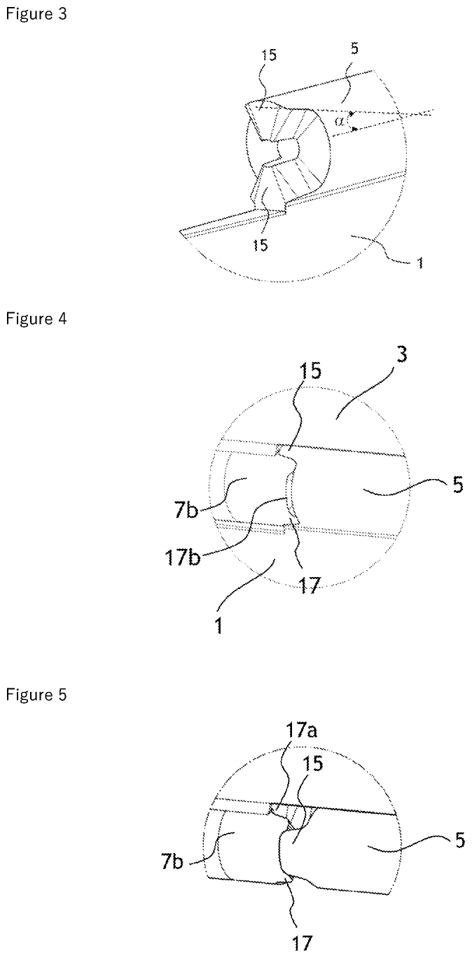

According to a first embodiment, FIG. 1, the elastic means is a compression spring 11 mounted about the axis of rotation A1, between a first part 7a of the hinge component 7 fastened to the fastening base 3 and the hinge component 5 fastened to the wing 1. Reciprocal rotation blocking means 15, 17 are borne, FIGS. 2 and 3, by the hinge component 5 fastened to the wing 1 and by a second part 7b of the hinge component fastened to the fastening base 3 and are arranged in opposition to the compression spring 11. In other words, the compression spring 11 is received in a housing 6 of the hinge component 5 fastened to the wing 1 and in a housing 8 of the hinge component 7 fastened to the fastening base 3, whereas the reciprocal rotation blocking means 15, 17 borne by each hinge component are opposite the housings 6, 8 respectively.

The reciprocal blocking means 15 borne by the hinge component 5 fastened to the wing 1 comprise, FIG. 2 and FIG. 3, projecting reliefs, of shape matching with hollow reliefs 17a, 17b of the blocking means 17 borne by the first part 7a of the hinge component 7 fastened to the fastening base 3. The matching shapes ensure efficient rotational blocking of the two hinge components.

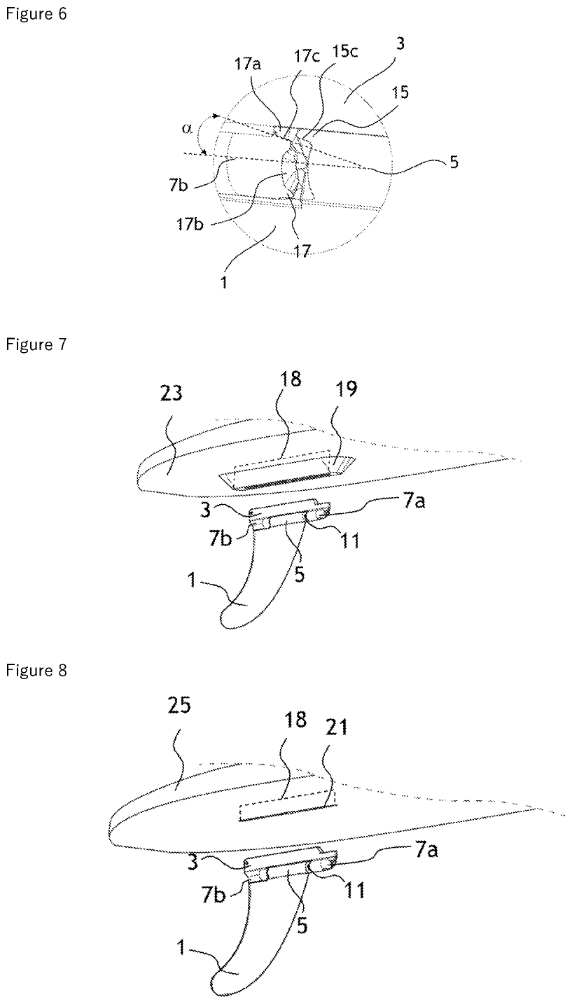

Preferably, the projecting reliefs borne by the hinge component 5 fastened to the wing 1 have a symmetry of order two, whereas the hollow reliefs borne by the first part 7a of the hinge component 7 fastened to the fastening base 3 have both a symmetry of order two and an alternation between a first type 17a and a second type 17b of hollow relief, defining respectively the two rotation blocking positions, stabilizing and folded, one perpendicular to the other. Again preferably, the hollow reliefs of the second type 17b extend less along the direction of the axis of rotation A1 than those of the first type 17a, to make it easier to rotate from the folded position to the stabilizing position. In other words, the spring 11 is compressed less to move in translation the hinge component 5 fastened to the wing 1 in a position that is free to rotate, FIG. 6, from the folded position, FIG. 5, than from the stabilizing position, FIG. 4.

Advantageously, the hollow reliefs 17a, 17b and the projecting reliefs 15 extend along edges 17c, 15c inclined by an angle alpha with respect to the direction of rotation A1, FIG. 3 and FIG. 6, to combine a rotational movement of the wing 1 along the axis of rotation A1, with a translational movement of the two hinge components 5, 7 with respect to each other in order to unblock the wing 1 from the stabilizing position or from the folded position. This arrangement thus gives the fin a rotation blocking threshold, beyond which the wing 1 is unblocked from the stabilizing position or from the folded position before it could be broken or damage the hinge components.

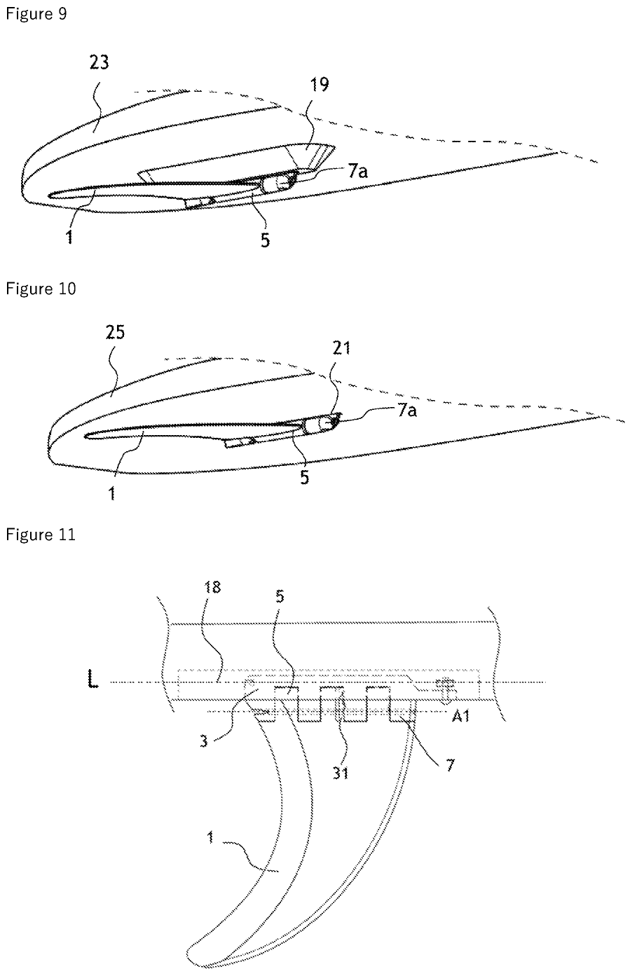

The fin is more particularly intended for an inflatable 23 or rigid-shell 25 water board. On FIGS. 7 and 8, it is assembled using a box 19, respectively 21, integrated in the water board 23, respectively 25. The box 19, 21 is provided with a housing 18 into which the fastening base 3 is inserted during assembly. The housing 18 extends in a plane perpendicular to the water board to provide a reference orientation to the fastening base 3. The hollow reliefs 17a, shown on FIG. 2, extend in the plane of the fastening base 3 and then in the plane of the housing 18 into which the fastening base 3 is inserted. This arrangement allows the wing 1 to be oriented perpendicular to the water board 23, 25 in the stabilizing position, FIG. 7 or FIG. 8 and then, parallel to this board in the folded position, FIG. 9 or FIG. 10. Note that the blocking means 15, 17 of the two hinge components can adopt any angular orientation about the axis of rotation A1, provided that the fastening base 3 and the wing 1 fastened respectively to the two hinge components 7, 5 extend in the same plane, in the stabilizing position.

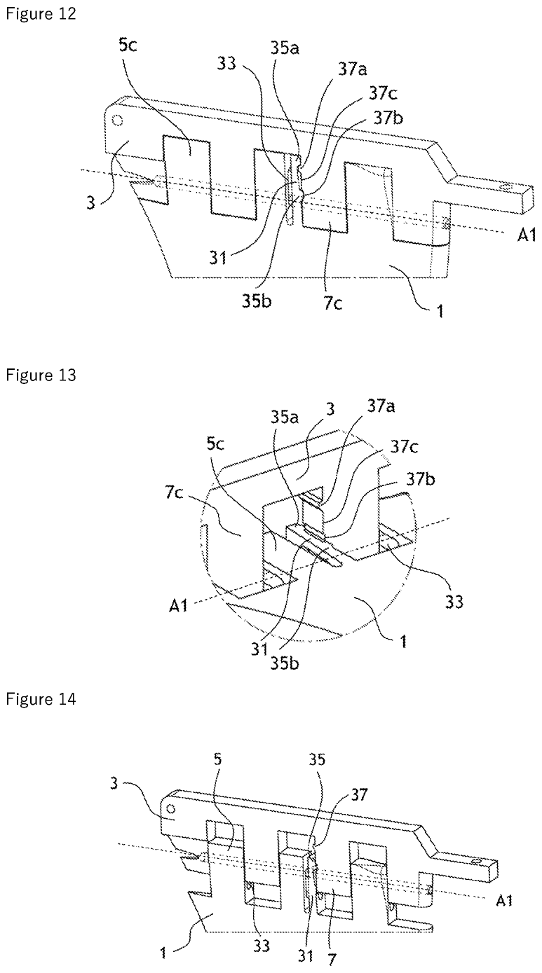

According to a second embodiment, FIG. 11, the elastic means is a bending arm 31 borne by the hinge component 5 fastened to the wing 1. These two elements 31, 5 are pierced, FIGS. 12 and 13, by an oblong hole 33 into which the axis of rotation A1 is inserted. The bending arm 31 and the hinge component 7 fastened to the fastening base 3 are provided with rotation blocking means 35, 37.

The blocking means 35 borne by the bending arm 31 of the hinge component 5 fastened to the wing 1 comprise ribs 35a, 35b. The blocking means 37 borne by the hinge component 7 fastened to the fastening base 3 comprise ribs 37a and grooves 37b. In the stabilizing position, FIG. 12, these means are engaged so as to arrange the wing 1 and the fastening base 3 in the same plane. The blocking means 37 borne by the hinge component 7 fastened to the fastening base 3 also comprise edges 37c which engage with the ribs 35a, 35b of the bending arm 31 in the folded position, FIG. 13.

Preferably, the ribs 37a and the ribs 37b of the hinge component 7 fastened to the fastening base 3 are perpendicular to the edges 37c to define the stabilizing position and the folded position perpendicular to each other.

Also preferably, the two hinge components comprise pins 5c, 7c which extend respectively in the plane of the wing 1 and of the fastening base 3 in the stabilizing position. The bending arm 31 and the blocking means 35, 37 are borne by the pins 5c, 7c in which the oblong hole 33 is formed to allow a translational movement of the hinge component 5 fastened to the wing 1 in a position, FIG. 14, that is unblocked in rotation. Note that one of the hinge components may comprise only one pin.

The bending arm 31 deforms against the translational movement of the hinge component 5 fastened to the wing 1, in order to unblock the wing 1 from the stabilizing position and move it to a position that is unblocked in rotation, from which the wing 1 is moved to the folded position. Inversely, the bending arm 31 deforms against a rotational movement about the axis of rotation A1, in order to unblock the wing 1 from the folded position and move it to a position that is unblocked in rotation, from which the wing 1 is moved in translation to the stabilizing position.

According to this second embodiment, the fin is assembled to an inflatable or rigid-shell water board according to the same principle as that described in relation to the first embodiment. Note that the pins 5c, 7c advantageously allow the hinge component 5 fastened to the wing 1 to be inserted into the housing 18 of the assembly box 19, 21 of the navigation object to improve the rotational blocking of the wing 1 in the stabilizing position, with respect to the blocking force of the bending arm 31.

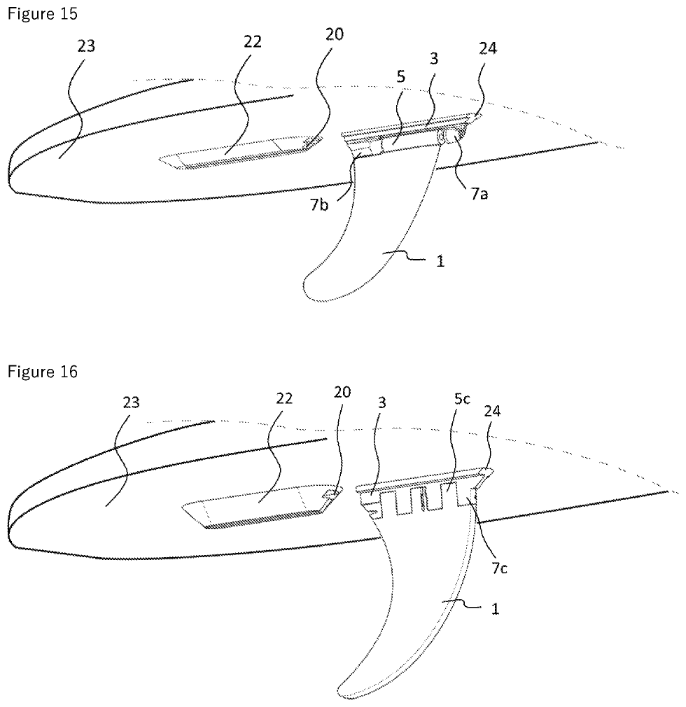

Another mode of assembly between the fin and a water board is shown on FIGS. 15 and 16, respectively for the first embodiment and for the second embodiment. The fastening base 3 is fastened to a rail 24 intended to be inserted into the housing 20 of the box 22. In the second embodiment, the housing 20 of the box 22 allows the pins 5c, 7c of the hinge component 5 fastened to the wing 1, to be inserted therein to improve the rotational blocking of the wing 1 in the stabilizing position, with respect to the blocking force of the bending arm 31.

This other mode of assembly is compatible with a water board, whether inflatable or rigid-shell.

1-9. (canceled)

10. A fin intended for a navigation object, in particular an inflatable or rigid-shell water board, comprising a wing which is able to move with respect to a fastening base about an axis of rotation between a first stabilizing position and a second folded position, and rotation blocking means, for blocking the wing in the folded position, the axis of rotation being borne by two hinge components, one of which is fastened to the wing and the other to the fastening base, the hinge component fastened to the wing also being able to move translationally with respect to the hinge component fastened to the fastening base in order to unblock the wing, wherein the rotation blocking means are borne by the two hinge components in order to block the wing in the folded position and in the stabilizing position and in that it comprises an elastic means that deforms in compression or in bending, against the translational movement of the hinge component fastened to the wing, unblocking the wing from the stabilizing position.

11. The fin according to claim 10, wherein the elastic means is a compression spring mounted about the axis of rotation, between a first part of the hinge component fastened to the fastening base and the hinge component fastened to the wing and opposite the rotation blocking means, borne by the hinge component fastened to the wing and by a second part of the hinge component fastened to the fastening base, said spring deforming in compression against the translational movement of the hinge component fastened to the wing in order to unblock the wing from the stabilizing position or from the folded position.

12. The fin according to claim 11, wherein the blocking means comprise projecting reliefs, borne by the hinge component fastened to the wing having a symmetry of order two and hollow reliefs, borne by the first part of the hinge component fastened to the fastening base and having both a symmetry of order two and an alternation between a first type and a second type of hollow relief, defining the stabilizing position and the folded position perpendicular to each other.

13. The fin according to claim 12, wherein the hollow reliefs of the second type extend less than those of the first type, to make it easier to rotate from the folded position to the stabilizing position, by reducing the compression of said spring to unblock the wing from the folded position with respect to the stabilizing position.

14. The fin according to claim 13, wherein the hollow reliefs and the projecting reliefs extend along edges inclined by an angle (alpha) with respect to the direction of rotation to combine a rotational movement of the wing along the axis of rotation, with a translational movement of the two hinge components with respect to each other in order to unblock the wing from the stabilizing position or from the folded position.

15. The fin according to claim 10, wherein the elastic means is a bending arm borne by the hinge component fastened to the wing, both of these two elements being pierced by an oblong hole into which the axis of rotation is inserted, the means for blocking the hinge component fastened to the wing being borne by the bending arm, which deforms in bending, against the translational movement of the hinge component fastened to the wing in order to unblock the wing from the stabilizing position and against a rotational movement about the axis of rotation, in order to unblock the wing from the folded position.

16. The fin according to claim 15, wherein the blocking means borne by the bending arm of the hinge component fastened to the wing comprise ribs, the blocking means borne by the hinge component fastened to the fastening base comprise ribs and grooves, these means being engaged so as to arrange the wing and the fastening base in the same plane in the stabilizing position, the blocking means borne by the hinge component fastened to the fastening base also comprising edges which engage with the ribs of the bending arm in the folded position.

17. The fin according to claim 16, wherein the ribs and the ribs of the hinge component fastened to the fastening base are perpendicular to the edges to define the stabilizing position and the folded position, perpendicular to each other.

18. The fin according to claim 15, wherein the two hinge components comprise pins which bear the bending arm and the blocking means and in which the oblong hole is formed.
